(19) United States
(12) Patent Application Publication
(10) Pub. No.: US 2025/0216517 A1
(43) Pub. Date: Jul. 3, 2025

(54) LIDAR RECEIVING SYSTEM AND LIDAR

(71) Applicant: HON HAI PRECISION INDUSTRY CO., LTD., New Taipei (TW)

(72) Inventor: YU-TING LIAO, New Taipei (TW)

(21) Appl. No.: 19/001,284

(22) Filed: Dec. 24, 2024

(30) Foreign Application Priority Data
Dec. 29, 2023 (CN) 202311870752.9

(51) Int. Cl. G01S 7/481

(52) U.S. Cl. CPC G01S 7/4816; G01S 7/4813; G01S 7/4814

(57) ABSTRACT

A LiDAR receiving system includes a substrate, a photonic integrated circuit board (PICB) on the substrate, a light guiding assembly and an optical amplifier each integrated on the PICB, and a photoelectric conversion device. The light guiding assembly includes an input coupling grating, a first optical waveguide, a second optical waveguide and an output coupling grating. The input coupling grating is configurated for coupling a first optical signal into the first optical waveguide, the first optical waveguide is configurated for transmitting the first optical signal, the optical amplifier is configurated for amplifying the first optical signal into a second optical signal, the second optical waveguide is configurated for transmitting the second optical signal to the output coupling grating, and the photoelectric conversion device is configurated for converting the second optical signal into an electrical signal.

### FIELD

The subject matter herein generally relates to the field of light laser detection and ranging (LiDAR), specifically LiDAR receiving systems and LiDAR.

### BACKGROUND

When the LiDAR receives light energy reflected by an object in the laser light path, the light energy reflected back to the LiDAR is low because the object is far away or the reflectivity of the object is low, therefore, the detection distance and the reduction of accuracy of the LiDAR are low. To amplify the light energy reflected to the LiDAR, many amplification circuit components or beam shaping components are needed to improve the receiving performance of the LiDAR, such that the LiDAR generally has a large size.

Therefore, there is room for improvement in the art.

### BRIEF DESCRIPTION OF THE DRAWINGS

Implementations of the present disclosure will now be described, by way of embodiment, with reference to the attached figures.

FIG. 1 is a front view of a LiDAR receiving system according to a first embodiment of the present disclosure.

FIG. 2 is a schematic structural diagram of an embodiment of an optical amplifier in the LiDAR receiving system shown in FIG. 1.

FIG. 3 is a top view of part of the LiDAR receiving system in FIG. 1.

FIG. 4 is a front view of a modified embodiment of the LiDAR receiving system in FIG. 1.

FIG. 5 is a top view of a part of the LiDAR receiving system in FIG. 4.

FIG. 6 is a front view of a LiDAR receiving system according to a second embodiment of the present disclosure.

FIG. 7 is a schematic structural diagram of a LiDAR according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to;” it specifically indicates open-ended inclusion or membership in the so-described combination, group, series, and the like. The disclosure is illustrated by way of example and not by way of limitation in the figures of the accompanying drawings in which references indicate similar elements. It should be noted that references to “an” or “one” embodiment in this disclosure are not necessarily to the same embodiment, and such references can mean “at least one”.

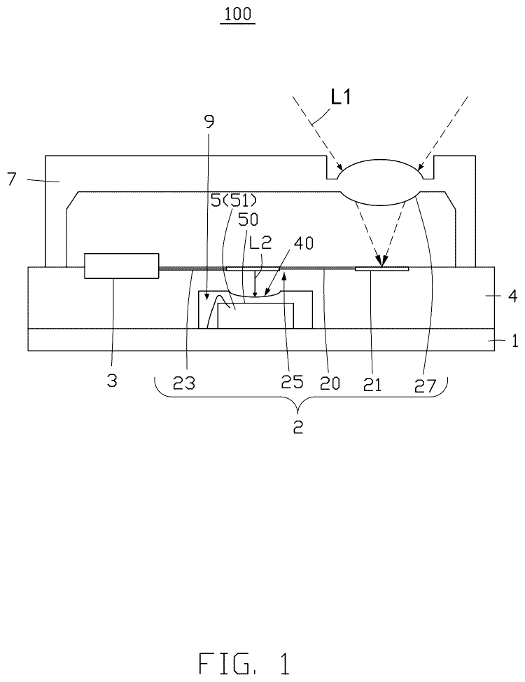

As shown in FIG. 1, a LiDAR receiving system 100 includes a substrate 1, a light guiding assembly 2, an optical amplifier 3, a photonic integrated circuit board (PICB) 4 and a photoelectric conversion device 5. The light guiding assembly 2 includes a first optical waveguide 20, an input coupling grating 21, a second optical waveguide 23 and an output coupling grating 25.

The input coupling grating 21 is configurated for receiving and coupling a first optical signal L1 into the first optical waveguide 20, and the first optical waveguide 20 is configurated for transmitting the first optical signal L1 to the optical amplifier 3. The optical amplifier 3 is configurated for receiving the first optical signal L1 emitted from the first optical waveguide 20 and amplifying the first optical signal L1 into a second optical signal L2, and the light intensity of the second optical signal L2 is greater than the light intensity of the first optical signal L1. The second optical waveguide 23 is configurated for transmitting the second optical signal L2 to the output coupling grating 25, and the output coupling grating 25 is configurated for coupling the second optical signal L2 for transmission.

The PICB 4 is arranged on the substrate 1, and the light guiding assembly 2 and the optical amplifier 3 are integrated on a side of the PICB 4 away from the substrate 1. The photoelectric conversion device 5 is configurated for receiving the second optical signal L2 and converting the second optical signal L2 into an electrical signal.

The LiDAR receiving system 100, the light guiding assembly 2 and the optical amplifier 3 are integrated on the PICB 4, and the light guiding assembly 2 can be processed on the PICB 4 by etching, so that the LiDAR receiving system 100 can achieve a small size and an ultra-compact structure, thereby further reducing the volume of the LiDAR receiving system 100.

In one embodiment, the first optical signal L1 is derived from a LiDAR transmitting system, and the wavelength of the first optical signal L1 includes 1550 nm. After the LiDAR transmitting system emits a detection light to free space, external objects in the free space reflect the detection light to form the first optical signal L1, and the first optical signal L1 can be received by the LiDAR receiving system 100.

In other embodiments, the first optical signal L1 can be derived from a mounted laser detection and ranging system installed on airplanes, automobiles, and ships. After the mounted laser detection and ranging system emits the detection light into free space, the receiving system of the mounted laser detection and ranging system can receive the first optical signal L1 formed by the reflection of the detection light.

In one embodiment, a size of the PICB 4 is a square of 2 cm×2 cm, and a substrate material of the PICB 4 is silicon. Using silicon as the substrate material of PICB 4 has the advantages of high conductivity and low cost. Since the substrate material of the PICB 4 depends on the overall application environment of the photonic integrated circuit, in other embodiments, the substrate material of the PICB 4 can be, but is not limited to, indium phosphide, silicon nitride or silicon-based optoelectronics.

The PICB 4 is further provided with a first focusing lens 40. The first focusing lens 40 is on the optical path of the second optical signal L2 and is configurated for converging the second optical signal L2 emitted from the output coupling grating 25 onto the photoelectric conversion device 5.

In one embodiment, the first focusing lens 40 is a convex mirror with a convex surface faces the substrate 1. In other embodiments, the first focusing lens 40 is a Fresnel lens, and a surface of the Fresnel lens is etched with a tiny, stepped structure for concentrating the second light signal L2. By arranging the first focusing lens 40 on the PICB 4, the second optical signal L2 emitted by the output coupling grating 25 is converged on the photoelectric conversion device 5, which is conducive to improving the receiving rate of the photoelectric conversion device and reducing the loss of the LiDAR receiving system 100.

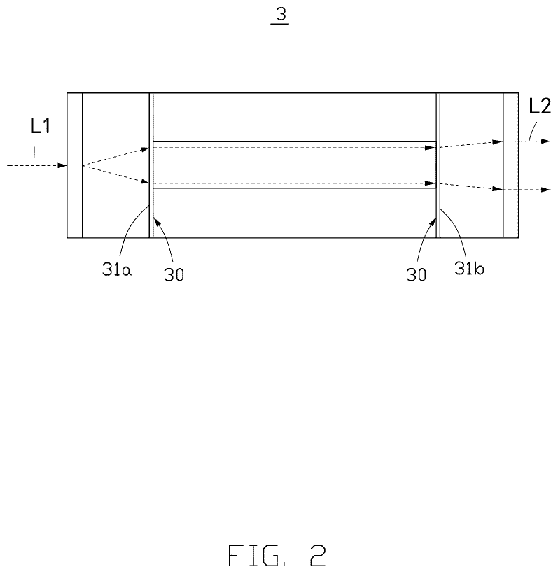

As shown in FIG. 2, the optical amplifier 3 is provided with antireflection films 30. The optical amplifier 3 includes a first end face 31a for receiving the first optical signal L1 and a second end face 31b for outgoing the second optical signal L2. The first end face 31a and the second end face 31b are all provided with antireflection films 30. The antireflection films 30 are configurated for reducing the reflection of the second optical signal L2 on the first end face 31a and the second end face 31b. By arranging the antireflection films 30 on the first end face 31a and the second end face 31b of the optical amplifier 3, it is conducive to amplifying the first optical signal L1 to the second optical signal L2 while reducing the loss in the amplification process and improving the utilization rate of light.

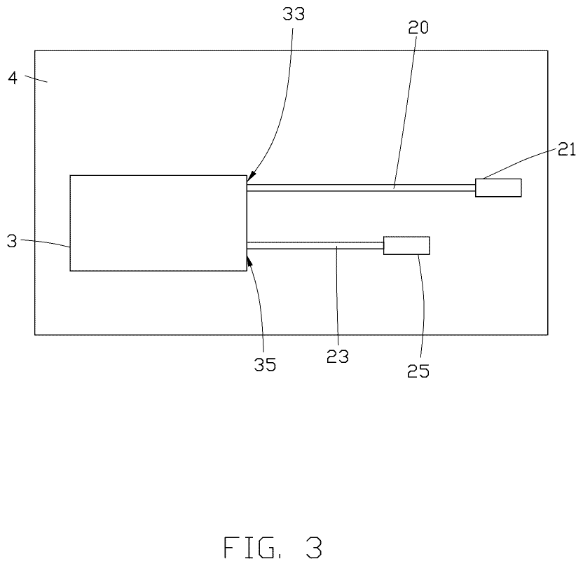

FIG. 3 is a top view of part of the LiDAR receiving system in FIG. 1. In order to show the positions of the first optical waveguide 20 and the second optical waveguide 23 more clearly, some components such as the substrate and the second focusing lens are not shown in the FIG. 3. The extension paths of the first optical waveguide 20 and the second optical waveguide 23 can be, but not limited to, regular straight lines or irregular curves.

As shown in FIG. 1 and FIG. 3, the first optical waveguide 20 and the second optical waveguide 23 are arranged on the surface of the PICB 4 far away from the substrate 1. The optical amplifier 3 includes an input terminal 33 and an output terminal 35 facing the same direction as the input terminal 33. The first optical waveguide 20 is coupled with the input terminal 33 of the optical amplifier 3, and the second optical waveguide 23 is coupled with the output terminal 35 of the optical amplifier 3. The first optical waveguide 20 is between the input coupling grating 21 and the optical amplifier 3. Since the output coupling grating 25 is also arranged between the optical amplifier 3 and the input coupling grating 21. That is, both the first optical waveguide 20 and the second optical waveguide 23 are between the optical amplifier 3 and the input coupling grating 21.

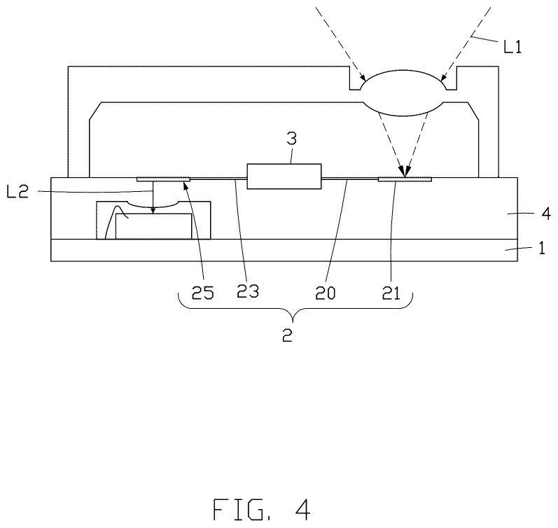

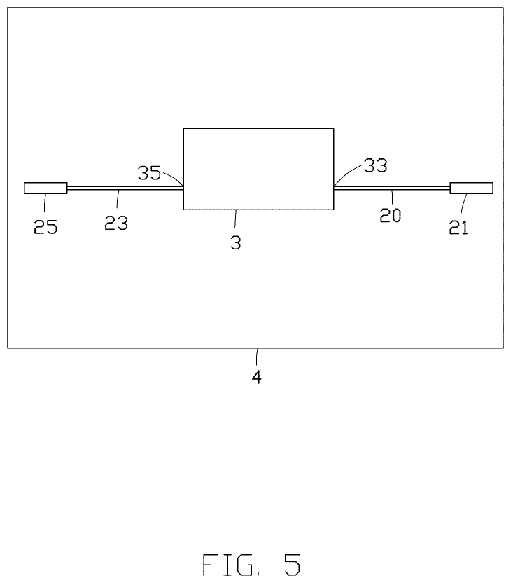

FIG. 5 is a top view of part of the LiDAR receiving system in FIG. 4. To show the positions of the first optical waveguide 20 and the second optical waveguide 23 more clearly, some components such as the substrate and the second focusing lens are not shown in FIG. 5.

As shown in FIG. 4 and FIG. 5, the first optical waveguide 20 and the second optical waveguide 23 are arranged on the surface of the PICB 4 away from the substrate 1. The optical amplifier 3 includes an input terminal 33 and an output terminal 35 facing opposite the input terminal 33. The first optical waveguide 20 is between the input coupling grating 21 and the optical amplifier 3. The output coupling grating 25 is arranged at the end of the optical amplifier 3 away from the input coupling grating 21, that is, the second optical waveguide 23 is between the optical amplifier 3 and the output coupling grating 25. The first optical waveguide 20 and the second optical waveguide 23 are respectively coupled to the input terminal 33 and the output terminal 35 of the optical amplifier 3.

In one embodiment, since the first optical waveguide 20 and the second optical waveguide 23 are arranged at different sides of the optical amplifier 3, the processing difficulty can be reduced during etching micro-processing, and the processing efficiency can be improved.

The preparation process of the first optical waveguide 20 and the second optical waveguide 23 usually requires two processes. First, an optical waveguide film is made on the surface of the PICB 4 away from the substrate 1 by using atomic doping technology, deposition technology, epitaxial growth technology or electro-optical technology, and then the optical waveguide film is chemical etched or ion beam etched to form the light guiding assembly 2 and integrate the optical amplifier 3 so as to finally form the photonic integrated circuit.

As shown in FIG. 1, the photoelectric conversion device 5 is arranged on a side of the substrate 1 close to the PICB 4. The photoelectric conversion device 5 is electrically connected with the substrate 1. The photoelectric conversion device 5 includes a light receiving surface 50 for receiving the second optical signal L2 coupled from the output coupling grating 25. The light receiving surface 50 is arranged on a side of the first focusing lens 40 close to the substrate 1. When the second optical signal L2 is incident on the photoelectric conversion device 5, the second optical signal L2 is received by the light receiving surface 50 of the photoelectric conversion device 5, and an electrical signal (such as photocurrent) is formed after the second optical signal L2 is absorbed.

In one embodiment, the photoelectric conversion device 5 is an avalanche photodiode 51, which receives the second optical signal L2 transmitted by the output coupling grating 25 and converts the second optical signal L2 into the electrical signal. By using the avalanche photodiode 51, light in the wavelength range of 900 nm to 700 nm can be received, which meets the requirement that the LiDAR receiving system 100 needs to detect light with a wavelength of 1550 nm.

In other embodiments, different photoelectric conversion devices 5 can be selected according to the wavelength of the light wave to be detected, such as but not limited to silicon photomultiplier tubes and single photon avalanche devices.

The substrate 1 is a printed circuit board made of organic materials (such as phenolic resin, glass fiber/epoxy resin and polyimide) or inorganic materials (such as aluminum or ceramics). The substrate 1 is connected to the PICB 4 by welding or bonding. The substrate 1 is provided with circuit traces.

In one embodiment, the substrate 1 and the PICB 4 are electrically connected to supply power to the optical amplifier 3. A receiving space 9 is formed between the substrate 1 and the PICB 4. The receiving space 9 is below the output coupling grating 25 and is configurated to accommodate the photoelectric conversion device 5, thus reducing the difficulty of aligning the photoelectric conversion device 5 with the output coupling grating 25 during actual processing.

As shown in FIG. 1, the LiDAR receiving system 100 further includes a housing 7. The housing 7 is on a side of the PICB 4 away from the substrate 1 and covers an area where the light guiding assembly 2 and the optical amplifier 3 are arranged. The housing 7 is configurated to seal the light guiding assembly 2 and the optical amplifier 3.

In one embodiment, the housing 7 can provide a vacuum or an environment filled with protective gases for the LiDAR receiving system 100, thereby prolonging the life of the lidar receiving system 100. The protective gases can be but not limited to chemically stable gases such as helium (He), neon (Ne), and argon (Ar). The housing 7 seals and protects the light guiding assembly 2 and the optical amplifier 3, which is conducive to enhancing the stability of the LiDAR receiving system 100.

The light guiding assembly 2 further includes a second focusing lens 27. The second focusing lens 27 is configurated for receiving the first optical signal L1 and converging and emitting the first optical signal L1 to the input coupling grating 21. The second focusing lens 27 is supported by the housing 7.

In one embodiment, the housing 7 has a light inlet, the second focusing lens 27 is bonded to the housing 7 and closes the light inlet of the housing 7. In other embodiments, the second focusing lens 27 and the housing 7 can be integrally formed of glass or resin. By providing the second focusing lens 27, it is beneficial to improve the light receiving rate of the LiDAR receiving system 100 and reduce the unnecessary loss of the first optical signal L1.

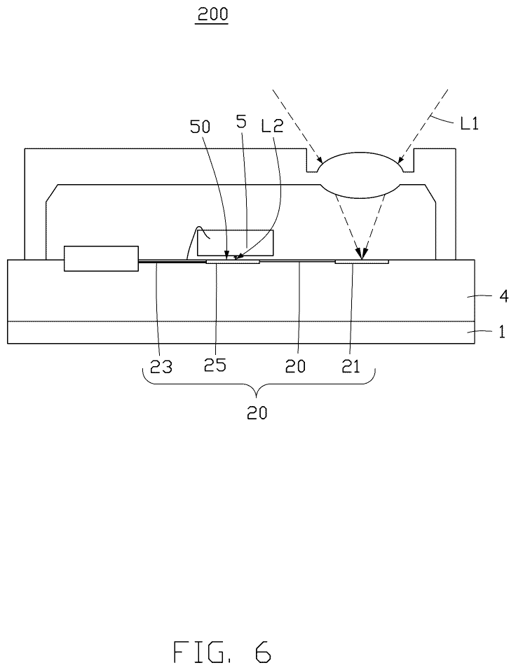

As shown in FIG. 6, the LiDAR receiving system 200 is different from the LiDAR receiving system 100 in that the photoelectric conversion device 5 is arranged on a side of the PICB 4 away from the substrate 1. That is, the photoelectric conversion device 5 and the light guiding assembly 2 are arranged on the same side of the PICB 4. The photoelectric conversion device 5 includes a light receiving surface 50. The light receiving surface 50 is above the side of the output coupling grating 25 away from the substrate 1 and is configurated for receiving the second optical signal L2 coupled out from the output coupling grating 25. The photoelectric conversion device 5 is electrically connected with the PICB 4.

In one embodiment, the substrate 1 is a printed circuit board, which supports and fixes the whole LiDAR receiving system 200. In the LiDAR receiving system 200, the photoelectric conversion device 5 is arranged on the PICB 4, which is beneficial to reducing the production difficulty in the actual production process, thereby improving the production efficiency.

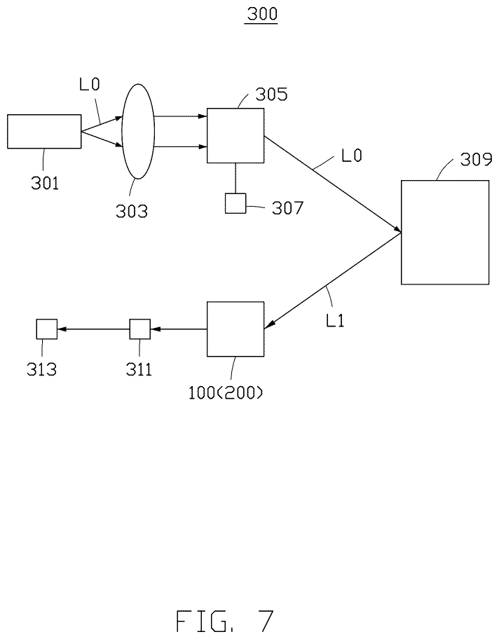

As shown in FIG. 7, a LiDAR 300 includes a light source 301 and the LiDAR receiving system 100(200) in any of the above embodiments. The light source 301 is configurated to emit a detection light L0, and the detection light L0 reflects the first optical signal L1 after encountering an external object 309. The LiDAR receiving system 100(200) is configurated to receive the first optical signal L1.

Specifically, the LiDAR 300 further includes a collimating module 303, an optical phased array module 305, a controller 307, a transimpedance amplifier 311 and an analog-to-digital converter 313.

The detection light L0 emitted by the light source 301 first passes through a collimating module 303, and then passes through the optical phased array module 305. The collimating module 303 is configurated to focus and collimate the detection light L0 emitted by the light source 301.

The optical phased array module 305 is electrically connected with the controller 307. The optical phased array module 305 is configurated to control the scanning direction of the detection light L0. The controller 307 is configurated for providing a detection signal for controlling the detection range of the detection light L0.

After the detection light L0 emitted from the optical phased array module 305 reaches free space, it is reflected by the external object 309 to form the first optical signal L1, and the LiDAR receiving system 100(200) receives the first optical signal L1 reflected by the external object 309.

The LiDAR receiving system 100(200) amplifies the first optical signal L1 into a second optical signal and converts the second optical signal from an optical signal into an electrical signal, which is a current signal. The current signal passes through the transimpedance amplifier 311, and the transimpedance amplifier 311 receives the current signal transmitted by the photoelectric conversion device and amplifies the current signal into a voltage signal. Finally, the voltage signal is converted into discrete digital signals by the analog-to-digital converter 313, thus facilitating signal processing and data conversion, and facilitating computer control and calculation.

The LiDAR 300 has the same beneficial effects as the above-mentioned LiDAR receiving system 100(200) and will not be repeated here.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A LIDAR receiving system comprising:
a substrate;
a photonic integrated circuit board (PICB) on the substrate and electrically connected to the substrate;
a light guiding assembly and an optical amplifier each integrated on a side of the PICB away from the substrate; and
a photoelectric conversion device electrically connected to the substrate;
wherein the light guiding assembly comprises an input coupling grating, a first optical waveguide, a second optical waveguide and an output coupling grating, the input coupling grating is configurated for coupling a first optical signal into the first optical waveguide, the first optical waveguide is configurated for transmitting the first optical signal, the optical amplifier is configurated for receiving the first optical signal emitted from the first optical waveguide and amplifying the first optical signal into a second optical signal, a light intensity of the second optical signal is greater than a light intensity of the first optical signal, the second optical waveguide is configurated for transmitting the second optical signal to the output coupling grating, and the output coupling grating is configurated for coupling the second optical signal for transmission, and the photoelectric conversion device is configurated for converting the second optical signal into an electrical signal.

2. The LiDAR receiving system according to claim 1, wherein the PICB comprises a first focusing lens in an optical path of the second optical signal, and the first focusing lens is configurated for converging the second optical signal emitted by the output coupling grating onto the photoelectric conversion device.

3. The LiDAR receiving system according to claim 2, wherein the photoelectric conversion device is directly electrically connected to the substrate and on a side of the substrate close to the PICB, and the photoelectric conversion device has a light receiving surface on a side of the first focusing lens close to the substrate.

4. The LiDAR receiving system according to claim 1, wherein the photoelectric conversion device is electrically connected to the substrate through the PICB and on a side of the PICB away from the substrate, the photoelectric conversion device has a light receiving surface above a side of the output coupling grating away from the substrate, and the light receiving surface is configurated for receiving the second optical signal coupled out from the output coupling grating.

5. The LiDAR receiving system according to claim 1, wherein the photoelectric conversion device is an avalanche photodiode, a silicon photomultiplier tube or a single-photon avalanche device.

6. The LiDAR receiving system according to claim 1 further comprising a housing on a side of the PICB away from the substrate, wherein the housing covers an area where the light guiding assembly and the optical amplifier are arranged.

7. The LiDAR receiving system according to claim 6, wherein the light guiding assembly further comprises a second focusing lens, and the second focusing lens is configurated for receiving the first optical signal and converging and emitting the first optical signal to the input coupling grating.

8. The LiDAR receiving system according to claim 1, wherein the optical amplifier comprises an input terminal and an output terminal facing a same direction as the input terminal, the first optical waveguide is connected between the input terminal and the input coupling grating, and the second optical waveguide is connected between the output terminal and the output coupling grating.

9. The LiDAR receiving system according to claim 1, wherein the optical amplifier comprises an input terminal and an output terminal facing opposite to the input terminal, the first optical waveguide is connected between the input terminal and the input coupling grating, and the second optical waveguide is connected between the output terminal and the output coupling grating.

10. The LiDAR receiving system according to claim 1 further comprising a antireflection film, wherein the optical amplifier comprises a first end face for receiving the first optical signal and a second end face for emitting the second optical signal, the antireflection film is on the first end face and the second end face, and is configurated for reducing a reflection of the second optical signal on the first end face and the second end face.

11. A LIDAR comprising:
a light source configurated for emitting a detection light, wherein the detection light reflects a first optical signal after encountering an external object; and
a LIDAR receiving system comprising:
a substrate;
a PICB on the substrate and electrically connected to the substrate;
a light guiding assembly and an optical amplifier each integrated on a side of the PICB away from the substrate; and
a photoelectric conversion device electrically connected to the substrate;
wherein the light guiding assembly comprises an input coupling grating, a first optical waveguide, a second optical waveguide and an output coupling grating, the input coupling grating is configurated for coupling the first optical signal into the first optical waveguide, the first optical waveguide is configurated for transmitting the first optical signal, the optical amplifier is configurated for receiving the first optical signal emitted from the first optical waveguide and amplifying the first optical signal into a second optical signal, alight intensity of the second optical signal is greater than a light intensity of the first optical signal, the second optical waveguide is configurated for transmitting the second optical signal to the output coupling grating, and the output coupling grating is configurated for coupling the second optical signal for transmission, and the photoelectric conversion device is configurated for converting the second optical signal into an electrical signal.

12. The LiDAR according to claim 11, wherein the PICB comprises a first focusing lens in an optical path of the second optical signal, and the first focusing lens is configurated for converging the second optical signal emitted by the output coupling grating onto the photoelectric conversion device.

13. The LiDAR according to claim 11, wherein the photoelectric conversion device is directly electrically connected to the substrate and on a side of the substrate close to the PICB, and the photoelectric conversion device has a light receiving surface on a side of the first focusing lens close to the substrate.

14. The LiDAR according to claim 11, wherein the photoelectric conversion device is electrically connected to the substrate through the PICB and on a side of the PICB away from the substrate, the photoelectric conversion device has a light receiving surface above a side of the output coupling grating away from the substrate, and the light receiving surface is configurated for receiving the second optical signal coupled out from the output coupling grating.

15. The LiDAR according to claim 11, wherein the photoelectric conversion device is an avalanche photodiode, a silicon photomultiplier tube or a single-photon avalanche device.

16. The LiDAR according to claim 11, wherein the LiDAR receiving system further comprises a housing on a side of the PICB away from the substrate, wherein the housing covers an area where the light guiding assembly and the optical amplifier are arranged.

17. The LiDAR according to claim 16, wherein the light guiding assembly further comprises a second focusing lens, and the second focusing lens is configurated for receiving the first optical signal and converging and emitting the first optical signal to the input coupling grating.

18. The LiDAR according to claim 11, wherein the optical amplifier comprises an input terminal and an output terminal facing a same direction as the input terminal, the first optical waveguide is connected between the input terminal and the input coupling grating, and the second optical waveguide is connected between the output terminal and the output coupling grating.

19. The LiDAR according to claim 11, wherein the optical amplifier comprises an input terminal and an output terminal facing opposite to the input terminal, the first optical waveguide is connected between the input terminal and the input coupling grating, and the second optical waveguide is connected between the output terminal and the output coupling grating.

20. The LiDAR according to claim 11, wherein the LiDAR receiving system further comprises a antireflection film, the optical amplifier comprises a first end face for receiving the first optical signal and a second end face for emitting the second optical signal, the antireflection film is on the first end face and the second end face, and is configurated for reducing a reflection of the second optical signal on the first end face and the second end face.
